(19) United States
(12) Patent Application Publication
(10) Pub. No.: US 2011/0187196 A1
(43) Pub. Date: Aug. 4, 2011

(54) PHOTOVOLTAIC POWER GENERATION SYSTEMS AND METHODS

(76) Inventor: Simdong YEO, Seoul (KR)

(21) Appl. No.: 12/976,621

(22) Filed: Dec. 22, 2010

(30) Foreign Application Priority Data
Feb. 1, 2010 (KR) 10-2010-0009141

(51) Int. Cl. H02J 5/00

(52) U.S. Cl. 307/66

(57) ABSTRACT

A photovoltaic power generation system, includes: a photovoltaic power generator configured to output an electrical power generated using light; an inverter configured to convert the generated electrical power into an alternating current (AC) power and supply the AC power to a commercial power source or to a load; a capacitor configured to store the generated electrical power; and a monitor configured to direct the generated electrical power to the inverter or the capacitor based on an operation mode selected by a user.

This application claims priority to and the benefit of Korean Patent Application No. 10-2010-0009141 filed in the Korean Intellectual Property Office on Feb. 1, 2010, the entire contents of which are incorporated by reference for all purposes as if set forth herein.

### BACKGROUND

1. Field of the Invention

Exemplary embodiments of the invention relate to photovoltaic power generation systems and methods.

2. Description of the Related Art

Recently, as existing energy sources such as petroleum and coal are expected to be depleted, interests in alternative energy sources for replacing the existing energy sources are increasing. Hence, a photovoltaic power generator using solar cells generating electric energy from solar energy has been spotlighted.

The photovoltaic power generator is applied to a stand-alone photovoltaic power generation system and a grid-connection photovoltaic power generation system based on a manner of using the power output from the photovoltaic power generator.

The stand-alone photovoltaic power generation system is a system in which the power generated in the photovoltaic power generator is stored in a capacitor and then is used when there is a demand for the power. The grid-connection photovoltaic power generation system is a system in which the power generated in the photovoltaic power generator is supplied to a load and excess power may be sold to electrical grid supplying a commercial power source.

### SUMMARY

In one aspect, there is a photovoltaic power generation system. The system may include: a photovoltaic power generator configured to output an electrical power generated using light; an inverter configured to convert the generated electrical power into an alternating current (AC) power and supply the AC power to a commercial power source or to a load; a capacitor configured to store the generated electrical power; and a monitor configured to direct the generated electrical power to the inverter or the capacitor based on an operation mode selected by a user.

The monitor may include: an operation mode selection receiver configured to receive an operation mode selection from the user and output an operation mode signal; a controller configured to receive the operation mode signal and output a control signal based on the operation mode signal; and a path selector configured to receive the control signal and select a path that directs the generated electrical power to the inverter or the capacitor based on the control signal.

The operation mode may be a load driving mode for driving the load using the generated electrical power, a power sale mode for selling the generated electrical power to the commercial power source, or a charging mode for storing the generated electrical power in the capacitor.

In the load driving mode, the controller may compare an amount of generated electrical power with an amount of electrical power required to drive the load. When the amount of generated electrical power is equal to or more than the required amount of electrical power, the controller may output a control signal for selecting a path that directs the generated electrical power to the load.

The controller may decide whether an excess generated electrical power exists. When the excess generated electrical power exists, the controller may output a control signal for storing the excess generated electrical power in the capacitor or for selling the excess generated electrical power to the commercial power source.

The controller may decide whether the capacitor is in a chargeable state. When the capacitor is in the chargeable state, the controller may output a control signal for storing the excess generated electrical power in the capacitor. When the capacitor is not in the chargeable state, the controller may output a control signal for selling the excess generated electrical power to the commercial power source.

When the amount of generated electrical power is less than the required amount of electrical power, the controller may output a control signal for supplying a commercial electrical power provided by the commercial power source or for supplying a stored electrical power of the capacitor to the load.

The controller may decide whether the stored electrical power exists in the capacitor. When the stored electrical power exists in the capacitor, the controller may output a control signal for supplying the stored electrical power to the load. When the stored electrical power does not exist in the capacitor, the controller may output a control signal for supplying the commercial electrical power to the load.

In the power sale mode, the controller may output a control signal for selecting a path that directs the generated electrical power to the commercial power source.

The controller may decide whether a stored electrical power exists in the capacitor. When the stored electrical power exists in the capacitor, the controller may compare an amount of stored electrical power with an amount of electrical power required to drive the load. When the amount of stored electrical power is equal to or more than the required amount of electrical power, the controller may output a control signal for selling the generated electrical power to the commercial power source and for supplying the stored electrical power to the load. When the amount of stored electrical power is less than the required amount of electrical power, the controller may output a control signal for selling the generated electrical power to the commercial power source and for supplying the stored electrical power and a commercial electrical power provided by the commercial power source to the load.

When the stored electrical power does not exist in the capacitor, the controller may output a control signal for selling the generated electrical power to the commercial power source and supplying the commercial electrical power to the load.

In the charging mode, the controller may decide whether the capacitor is in a chargeable state. When the capacitor is in the chargeable state, the controller may output a control signal for selecting a path directing the generated electrical power to the capacitor.

The controller may also output a control signal for supplying a commercial electrical power provided by the commercial power source to the load.

When the capacitor is not in the chargeable state, the controller may compare an amount of generated electrical power with an amount of electrical power required to drive the load. When the amount of generated electrical power is more than the required amount of electrical power, the controller may output a control signal for supplying a portion of the generated electrical power to the load and for supplying an excess generated electrical power to the commercial power source. When the amount of generated electrical power is less than the required amount of electrical power, the controller may output a control signal for supplying the generated electrical power and a commercial electrical power provided by the commercial power source to the load. When the amount of generated electrical power is substantially equal to the required amount of electrical power, the controller may output a control signal for supplying the generated electrical power to the load.

The system may include a display. The display may be configured to display an operation state of the photovoltaic power generation system in response to a control signal from the controller. The display may display an amount of generated electrical power, an amount of stored electrical power, an amount of sold electrical power, a sale price of electrical power, and a power intensity, in response to the control signal from the controller. The display may display a power flow state of the photovoltaic power generation system in response to the control signal from the controller.

In another aspect, there is a method for controlling a photovoltaic power generation system. The method may include: receiving an operation mode selection from a user; when the operation mode is a load driving mode; selecting a path of a generated electrical power from a photovoltaic power generator to a load; when the operation mode is a power sale mode, selecting a path of the generated electrical power from the photovoltaic power generator to a commercial power source; and when the operation mode is a charging mode, selecting a path of the generated electrical power from the photovoltaic power generator to a capacitor.

When the operation mode is a load driving mode, an amount of generated electrical power may be compared with an amount of electrical power required to drive the load.

When the amount of generated electrical power is equal to or more than the required amount of electrical power, whether an excess generated electrical power exists may be decided. When the excess generated electrical power exists, there may be a control signal output for storing the excess generated electrical power in the capacitor or for selling the excess generated electrical power to the commercial power source.

When the excess generated electrical power exists, whether the capacitor is in a chargeable state may be decided. When the capacitor is in the chargeable state, there may be a control signal output for supplying the generated electrical power to the load and storing the excess generated electrical power in the capacitor.

When the capacitor is not in the chargeable state, there may be a control signal output for supplying the generated electrical power to the load and selling the excess generated electrical power to the commercial power source.

When the amount of generated electrical power is less than the required amount of electrical power, there may be a control signal output for supplying commercial electrical power provided by the commercial power supply or a stored electrical power of the capacitor to the load.

When the amount of generated electrical power is less than the required amount of electrical power, whether the stored electrical power exists in the capacitor may be decided. When the stored electrical power exists in the capacitor, there may be a control signal output for supplying the generated electrical power and the stored electrical power to the load. When the stored electrical power does not exist in the capacitor, there may be a control signal output for supplying the generated electrical power and the commercial electrical power to the load.

When the operation mode is a power sale mode, whether a stored electrical power exists in the capacitor may be decided. When the stored electrical power exists in the capacitor, an amount of stored electrical power may be compared with an amount of electrical power required to drive the load. When the amount of stored electrical power is equal to or more than the required amount of electrical power, there may be a control signal output for supplying the generated electrical power to the commercial power source and for supplying the stored electrical power to the load. When the amount of stored electrical power is less than the required amount of electrical power, there may be a control signal output for selling the generated electrical power to the commercial power source and for supplying the stored electrical power and a commercial electrical power provided by the commercial power source to the load.

When the stored electrical power does not exist in the capacitor, there may be a control signal output for selling the generated electrical power to the commercial power source and for supplying the commercial electrical power to the load.

When the operation mode is a charging mode, whether the capacitor is in a chargeable state may be decided. When the capacitor is in the chargeable state, there may be a control signal output for supplying the generated electrical power to the capacitor.

When the capacitor is in the chargeable state, there may be a control signal output for supplying a commercial electrical power provided by the commercial power source to the load.

When the capacitor is not in the chargeable state, an amount of generated electrical power may be compared with an amount of electrical power required to drive the load. When the amount of generated electrical power is more than the required amount of electrical power, there may be a control signal output for supplying a portion of the generated electrical power to the load and for supplying an excess generated electrical power to the commercial power source.

When the amount of generated electrical power is less than the required amount of electrical power, there may be a control signal output for supplying the generated electrical power and a commercial electrical power provided by the commercial power source to the load.

When the amount of generated electrical power is substantially equal to the required amount of electrical power, there may be a control signal output for supplying the generated electrical power to the load by.

An operation state of the photovoltaic power generation system may be displayed on a display. The display may display a current power flow state of the photovoltaic power generation system. The display may display an amount of generated electrical power, an amount of stored electrical power, an amount of sold power, a sale price of the electrical power, and a power intensity.

In yet another aspect, there is a system for controlling a photovoltaic power generation system. The system may include: an operation mode selection receiver configured to receive an operation mode selection from an user and to output an operation mode signal; a controller configured to receive the operation mode signal and output a control signal based on the operation mode signal; and a path selector configured to received the control signal and select a path that directs an electrical power generated by a photovoltaic generator to an inverter or a capacitor based on the control signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic block diagram of a photovoltaic power generation system;

FIGS. 2A to 2C are flow charts illustrating a method for controlling a photovoltaic power generation system; and

FIGS. 3A to 3I illustrate examples of a power flow state displayed on a display of a photovoltaic power generation system.

### DETAILED DESCRIPTION OF THE ILLUSTRATED EMBODIMENTS

Embodiments of the invention will be described more fully hereinafter with reference to the accompanying drawings, in which examples are shown. This invention may, however, be embodied in many different forms and should not be construed as limited to the embodiments set forth herein. Like reference numerals designate like elements throughout the specification.

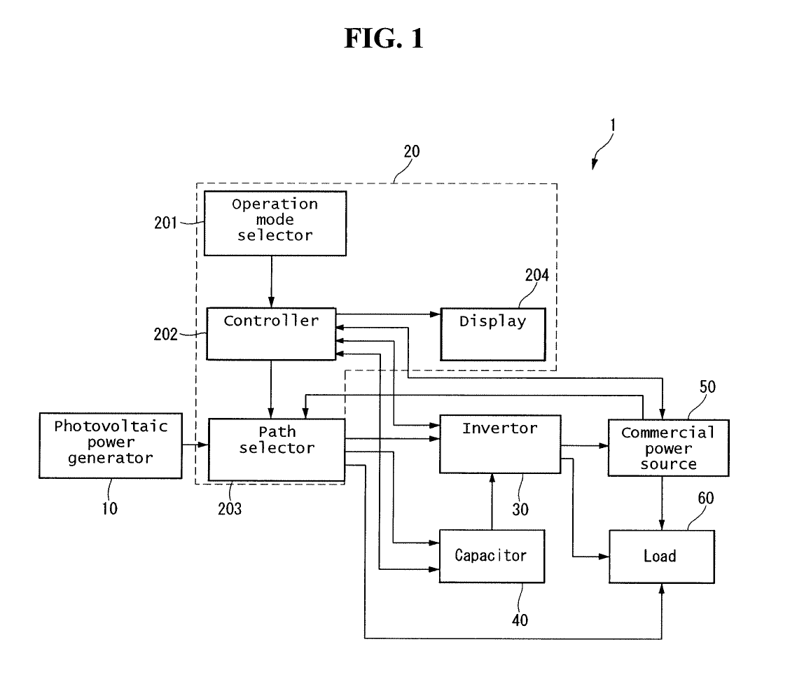

FIG. 1 is a schematic block diagram of a photovoltaic power generation system. As shown in FIG. 1, a photovoltaic power generation system 1 may include a photovoltaic power generator 10, a monitor 20 connected to the photovoltaic power generator 10, an inverter 30 and a capacitor 40 that are connected to the monitor 20, a commercial power source 50 connected to the inverter 30 and the monitor 20, and a load 60 connected to the monitor 20 and the inverter 30.

The photovoltaic power generator 10 may generate direct current (DC) power using light, for example solar light, and outputs the DC power. The photovoltaic power generator 10 may include a plurality of solar cell modules (not shown) electrically connected to one another and a power generating unit (not shown) connected to the plurality of solar cell modules. The solar cell modules may be arranged in a matrix structure, and each of the solar cell modules may include a plurality of solar cells (not shown) electrically connected to one another.

The monitor 20 may output the DC power received from the photovoltaic power generator 10 to a corresponding component based on an operation mode selected by a user. The monitor 20 may inform the user of an operation state of the photovoltaic power generation system 1. The monitor 20 may include an operation mode selection receiver 201, a controller 202, a path selector 203, and a display 204.

The operation mode selection receiver 201 may be operated by the user and may output an operation mode signal corresponding to the operation mode selected by the user. The operation mode may include a load driving mode for supplying electrical power generated in the photovoltaic power generator 10 to the load 60 to thereby drive the load 60, a power sale mode for outputting the generated electrical power to the commercial power source 50 to thereby sell the generated electrical power, and a charging mode for charging the capacitor 40 using the generated electrical power.

The operation mode selection receiver 201 may have separate switches for the load driving mode, the power sale mode, and the charging mode. In this case, each of the switches may be maintained in an on-state or an off-state based on a user's operation and may output a selection signal corresponding to the on-state or the off-state to the controller 202. Examples of the switch may include a push button switch, a touch screen, or etc.

Alternatively, the operation mode selection receiver 201 may have one switch for selecting one of the load driving mode, the power sale mode, and the charging mode. For example, the switch may use a variable resistor for varying a value of an output signal based on an operation degree or may use a touch screen capable of performing a mode selection using a number of contact operations.

The operation mode selection receiver 201 may be attached to the display 204 and thus may improve convenience of the user.

The controller 202 may decide the operation mode selected by the user by processing the operation mode signal received from the operation mode selection receiver 201 and may output a control signal for controlling the operation of the photovoltaic power generation system 1 based on the decided operation mode. The control signal may include a path control signal for controlling an operation of the path selector 203, a driving control signal for controlling an operation state of each of the inverter 30 and the capacitor 40, a display control signal for controlling a display state of the display 204, and the like.

The path selector 203 determines a transfer path of the generated electrical power transferred from the photovoltaic power generator 10 in response to the path control signal output by the controller 202.

The display 204 displays information about the corresponding operation state of the photovoltaic power generation system 1 in response to the display control signal output by the controller 202. The information displayed on the display 204 may include a power intensity, a currently generated amount of electrical power, a real-time amount of stored electrical power, a currently sold amount of electrical power, a sale price of the electrical power, a current power flow state of the photovoltaic power generation system 1, and the like. The display 204 may display an accumulated amount of generated electrical power, an accumulated amount of sold electrical power, a current date, current weather, and the like.

A communication between the controller 202 and the display 204 may be a wired or wireless communication. Other communications in the photovoltaic power generation system 1 may be wired or wireless communication.

The inverter 30 may receive the driving control signal from the controller 202 and convert the DC generated electrical power into alternating current (AC) power in response to the driving control signal. The inverter 30 may transfer the AC power to the commercial power source 50 or the load 60.

The capacitor 40 may receive the driving control signal from the controller 202, may store the generated electrical power in response to the driving control signal, and may output the stored electrical power to the inverter 30.

The commercial power source 50 may supply an external power source to the load 60 through the path selector 203, or receive, for example by buying, the AC power from the inverter 30.

The load 60 may operate using the generated electrical power supplied from the photovoltaic power generator 10, from the capacitor 40 or from the commercial electrical power provided by the commercial power source 50.

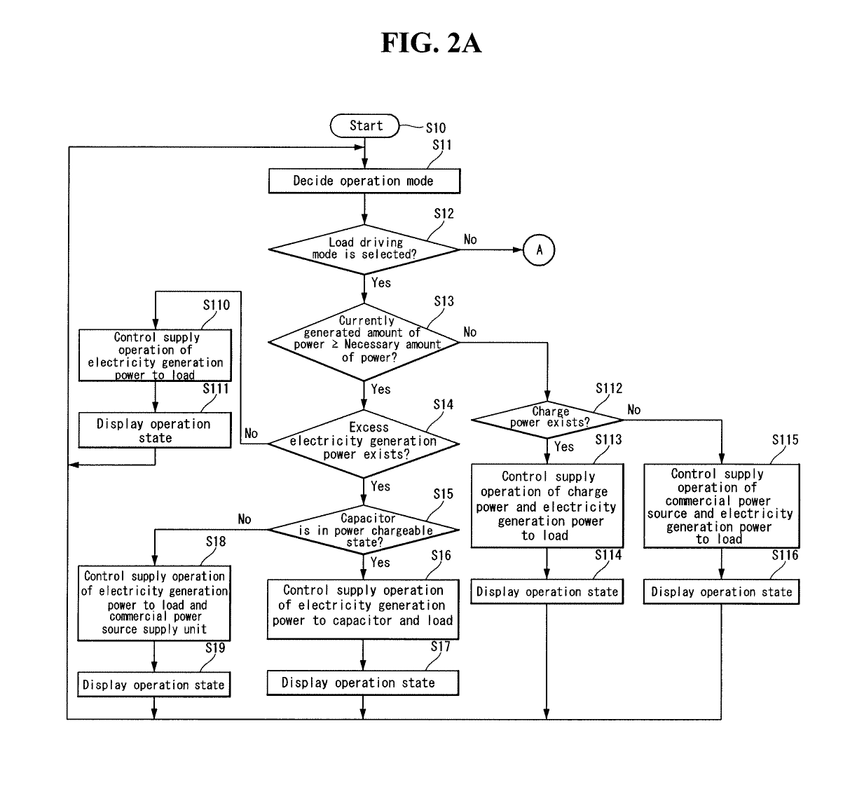

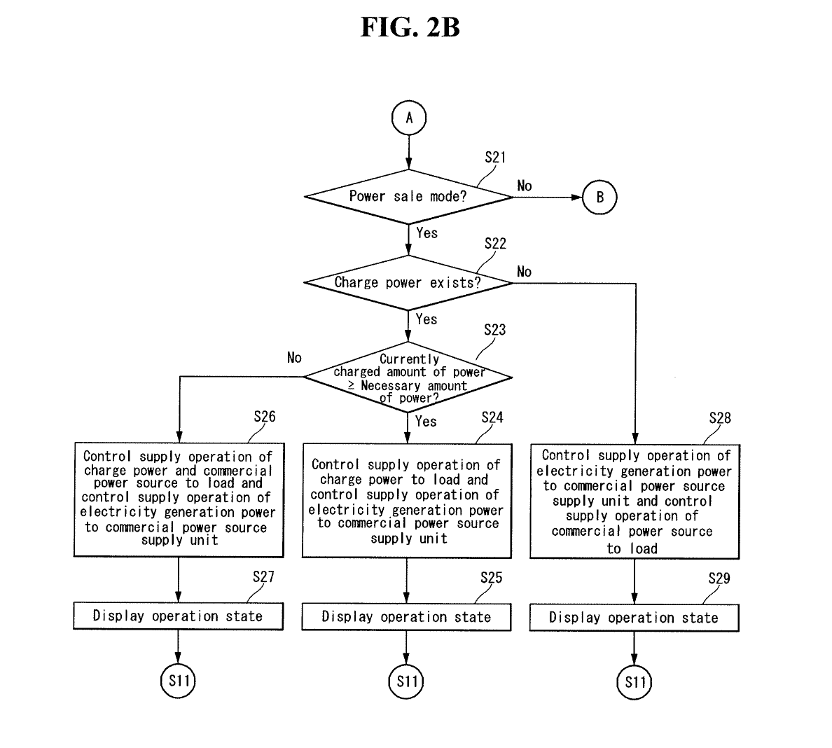

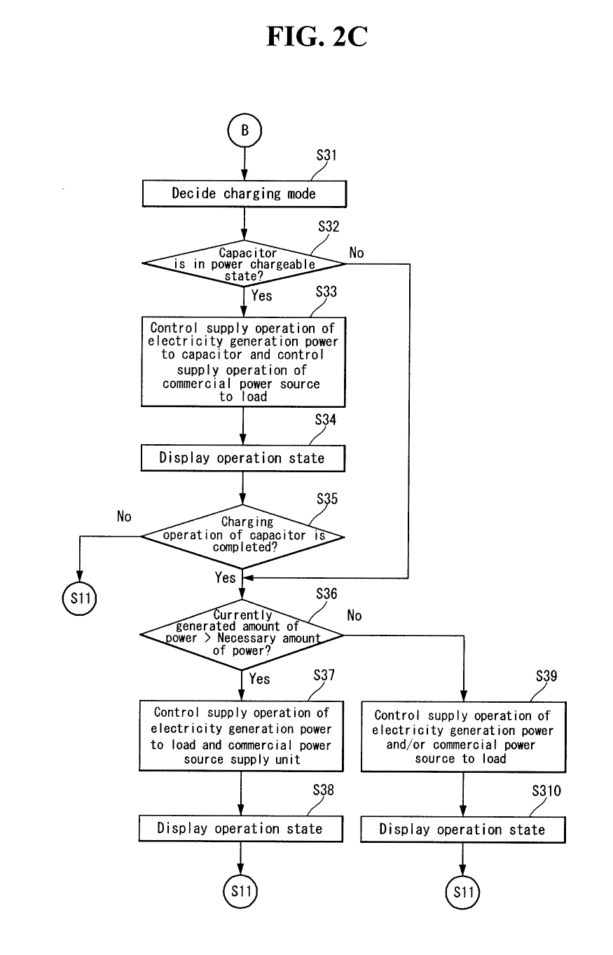

An operation of the photovoltaic power generation system 1 is described below with reference to FIGS. 2A to 2C and FIGS. 3A to 31.

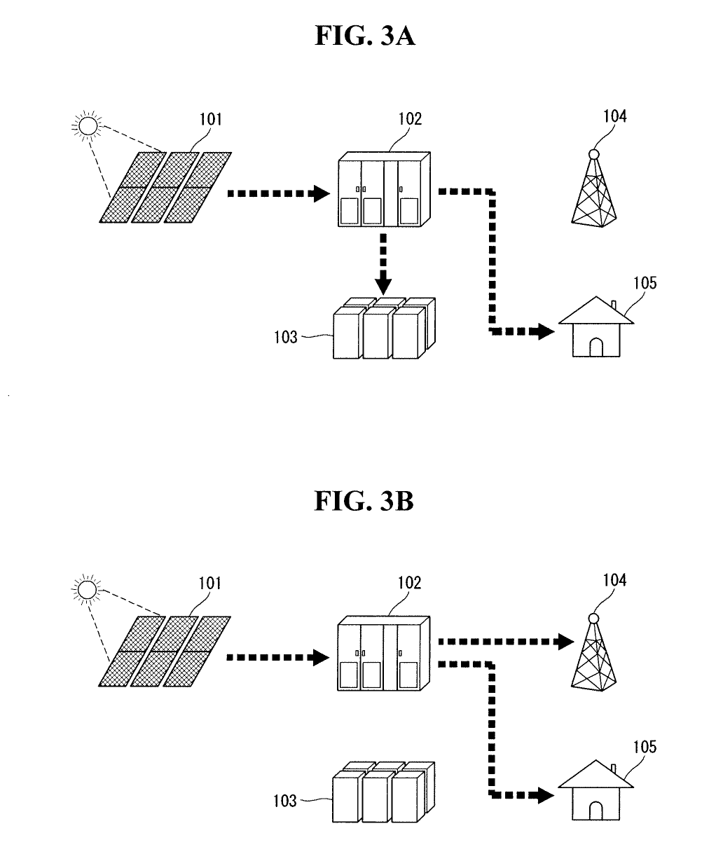

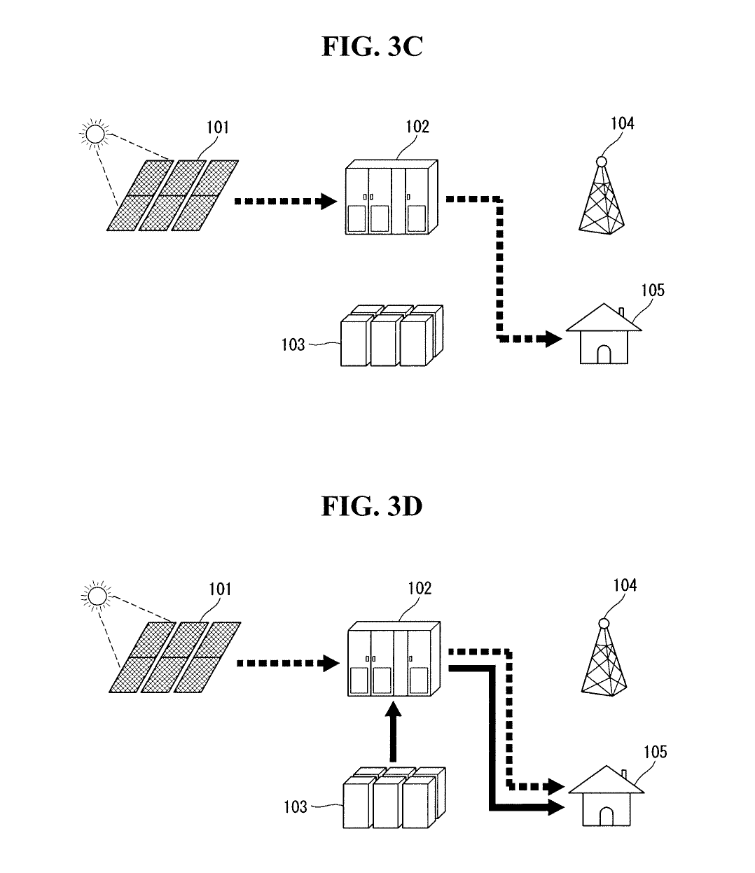

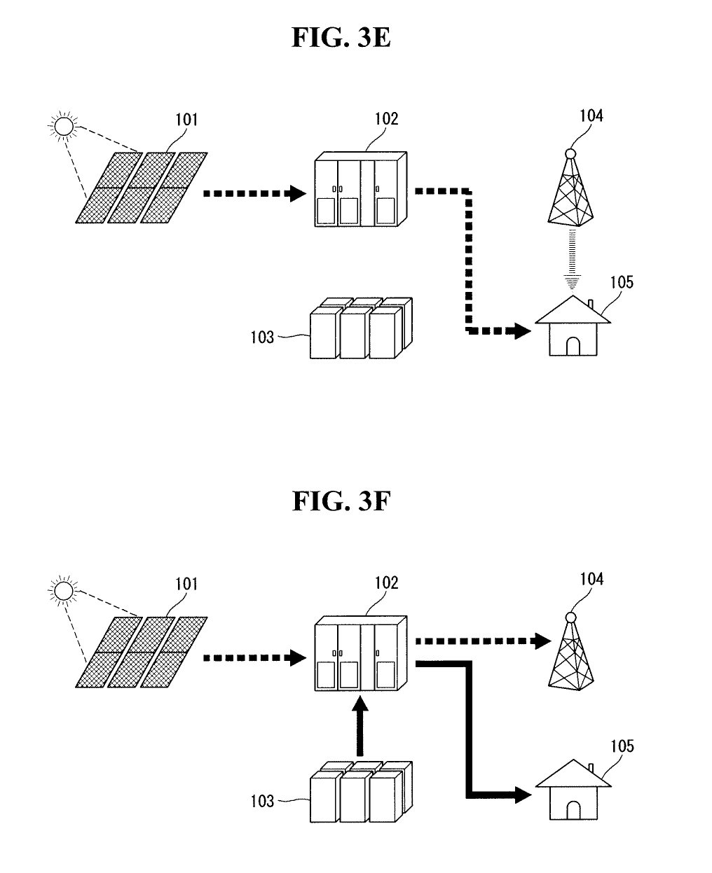

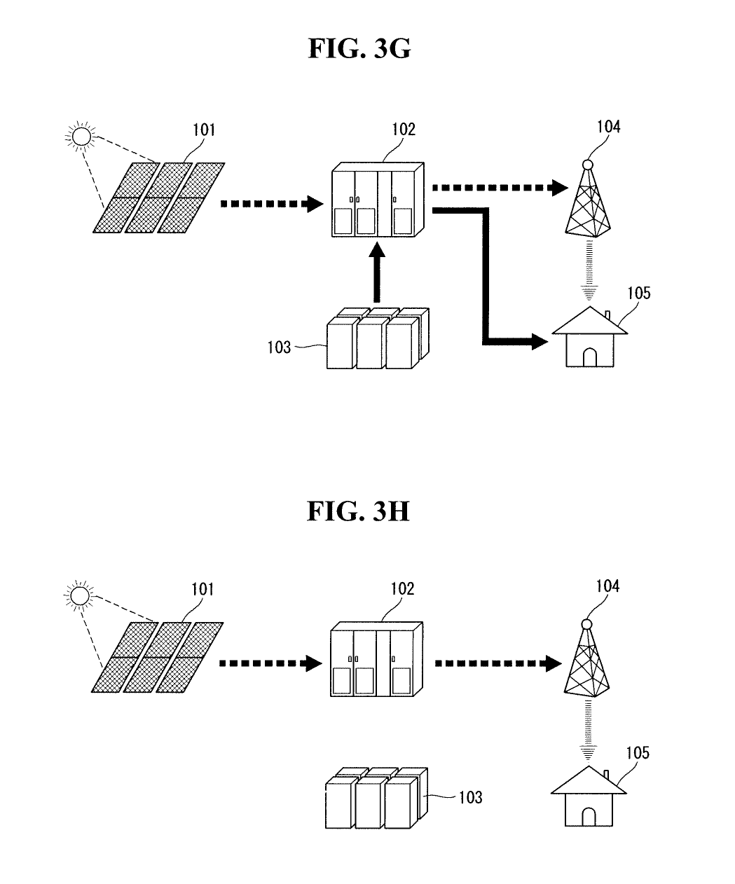

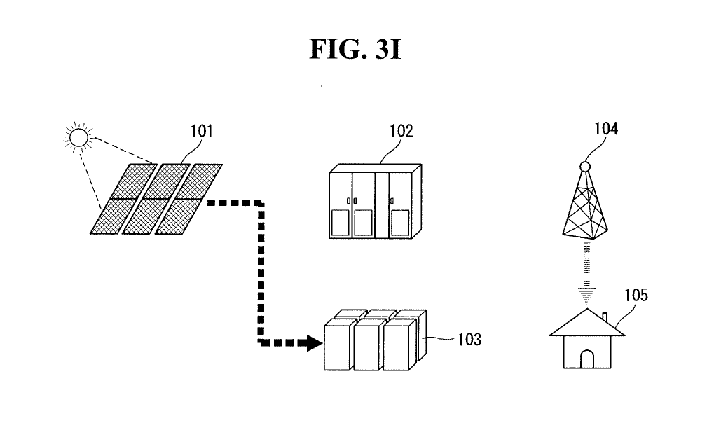

FIGS. 2A to 2C are flow charts illustrating a method for controlling a photovoltaic power generation system. FIGS. 3A to 3I illustrate examples of a current power flow state displayed on a display of a photovoltaic power generation system.

First, solar light may be converted into electric energy by an operation of solar cells included in the photovoltaic power generator 10, thereby generating direct current. The power generating unit included in the photovoltaic power generator 10 may generate solar power, such as DC generated electrical power based on the generated direct current and then may supply the DC generated electrical power to the path selector 203 of the monitor 20.

The controller 202 may control a supply operation of the DC generated electrical power from the path selector 203 to the inverter 30, the capacitor 40, or the load 60 based on an operation state of the operation mode selection receiver 201.

An operation of the controller 202 is described in detail below with reference to FIGS. 2A to 2C.

First, as shown in FIG. 2A, the controller 202 may read the operation mode signal received from the operation mode selection receiver 201 and decide the operation mode selected by the user in step S11.

When the operation mode is the load driving mode in step S12, the controller 202 may compare the currently generated amount of generated electrical power with an amount of electrical power required to drive the load 60 using the information received from the photovoltaic power generator 10 in step S13. The required amount of electrical power may have been already stored in a memory or may be real-time received from the load 60.

When the currently generated amount of generated electrical power is equal to or more than the required amount of electrical power, the controller 202 may perform a control operation for driving the load 60 using the electrical power generated by the photovoltaic power generator 10.

Thus, when the amount of generated electrical power from the photovoltaic power generator 10 is more than the amount of electrical power required to drive the load 60, the controller 202 may decide whether the excess generated electrical power exists in step S14.

When the excess generated electrical power exists, the controller 202 may check an amount of electrical power currently stored in the capacitor 40 and decide whether the capacitor 40 is in a power chargeable state in step S15. When the capacitor 40 is in the power chargeable state, such as when the capacitor 40 has not been completely charged, the controller 202 may output the path control signal of a corresponding state to the path selector 203 and output the driving control signal of a corresponding state to the inverter 30 and the capacitor 40 so that the generated electrical power may be supplied to the load 60 and the capacitor 40 in step S16.

Thus, the path selector 203 may supply a portion of the generated electrical power to the inverter 30 and supply a remaining generated electrical power to the capacitor 40. An amount of electricity generation supplied to each of the inverter 30 and the capacitor 40 may vary depending on the amount of generated electrical power.

The inverter 30 may convert the supplied generated electrical power into AC power in response to the driving control signal output from the controller 202 and then supply the AC power to the load 60. Hence, because the load 60 may be driven using the generated electrical power generated in the photovoltaic power generator 10 instead of the commercial power source that the user has to pay, electricity price may be reduced.

Further, because the capacitor 40 may be charged by the generated electrical power input based on the driving control signal output from the controller 202, an amount of electrical power stored in the capacitor 40 may increase. The capacitor 40 may output information about an operation state of the capacitor 40 to the controller 202.

In step S16, when power consumption of the load 60 is substantially zero or the load 60 is not connected to the photovoltaic power generation system 1 (such as when the required amount of electrical power is substantially zero), the controller 202 may control the operation of the path selector 203 so that the total generated electrical power applied to the load 60 is applied to the capacitor 40.

Next, the controller 202 may output a current operation state of the photovoltaic power generation system 1 to the display 204 based on the information received from the capacitor 40 in step S17.

Thus, the display 204 may display an operation state of the capacitor 40 including a real-time (current) charge amount of electrical power, charge intensity, etc., the currently generated amount of generated electrical power, the power consumption (the required amount of electrical power) of the load 60, the current power flow state of the photovoltaic power generation system 1, and the like.

The current power flow state of the photovoltaic power generation system 1 may be displayed on the display 204, such as by using the various contents 101 to 105 shown in FIGS. 3A to 3I. In FIGS. 3A to 3I, the current power flow state between the contents 101 to 105 is indicated by an arrow. In FIGS. 3A to 3I, a reference numeral 101 is the content representing the photovoltaic power generator, a reference numeral 102 is the content representing the inverter, a reference numeral 103 is the content representing the capacitor, a reference numeral 104 is the content representing the commercial power source, and a reference numeral 105 is the content representing the load.

The user may understand from the display screen of the display 204 illustrated in FIG. 3A that the generated electrical power generated in the photovoltaic power generator 10 may be supplied to the load 60 and the capacitor 40.

When the capacitor 40 is not in the power chargeable state (such as when the capacitor 40 has been has been completely charged) in step S15, the controller 202 may respectively output the path control signal of a corresponding state and the driving control signal of a corresponding state to the path selector 203 and the inverter 30 so that the generated electrical power may be supplied to the load 60 and the commercial power source 50 in step S18.

Thus, the path selector 203 may apply the total generated electrical power to the inverter 30.

The inverter 30 may convert the supplied generated electrical power into the AC power and then supply a portion of the AC power to the load 60 in response to the driving control signal output from the controller 202. Hence, the inverter 30 may drive the load 60 and supply a remainder of the AC to the commercial power source 50. In other words, the controller 202 may perform the control operation so that the excess generated electrical power that remains after driving the load 60 may be sold to the commercial power source 50. The commercial power source 50 may output information about the sale amount of generated electrical power and the sale price to the controller 202.

Similar to the process described in step S16, in step S18, when the power consumption of the load 60 is substantially zero or the load 60 is not connected to the photovoltaic power generation system 1, the controller 202 may control the operation of the path selector 203 so that the total generated electrical power applied to the load 60 may be applied to the commercial power source 50.

Next, the controller 202 may output a current operation state of the photovoltaic power generation system 1 to the display 204 based on the information received from the commercial power source 50 in step S19.

Thus, the display 204 may display the power consumption of the load 60, the sale amount of electrical power, the sale price corresponding to the sale amount of electrical power, the current power flow state of the photovoltaic power generation system 1, and the like. In this case, the display 204 may display the current power flow state illustrated in FIG. 3B. The user may understand from the display screen illustrated in FIG. 3B that the generated electrical power generated in the photovoltaic power generator 10 may be supplied to the load 60 and the commercial power source 50.

When the excess generated electrical power does not exist in step S14 (such as when the currently generated amount of generated electrical power is substantially equal to the required amount of electrical power), the controller 202 may output the path control signal of a corresponding state and the driving control signal of a corresponding state to the inverter 30 so that the generated electrical power may be supplied to the load 60 in step S110.

Hence, the inverter 30 may convert the total generated electrical power supplied through the path selector 203 into the AC power and then supply the AC power to the load 60 in response to the driving control signal. The total generated electrical power supplied through the path selector 203 may be consumed in the driving of the load 60.

Next, the controller 202 may output the current operation state of the photovoltaic power generation system 1 to the display 204 in step S111. Hence, the display 204 may display the currently generated amount of generated electrical power, the power consumption of the load 60, the current power flow state of the photovoltaic power generation system 1 illustrated in FIG. 3C, and the like.

When the controller 202 decides that the currently generated amount of generated electrical power is less than the required amount of electrical power in step S13 (such as when it is impossible to normally drive the load 60 using the currently generated amount of generated electrical power), the controller 202 may decide whether the stored electrical power exists in the capacitor 40 in step S112.

When the stored electrical power exists in the capacitor 40, the controller 202 may output the path control signal of a corresponding state to the path selector 203 and output the driving control signal of a corresponding state to the inverter 30 and the capacitor 40 in step S113.

Thus, the path selector 203 may supply the generated electrical power to the inverter 30, and also the capacitor 40 may supply a portion of the stored electrical power to the inverter 30. As a result, the inverter 30 may convert the DC power received from the path selector 203 and the capacitor 40 into the AC power and then supply the AC power to the load 60. In this case, an amount of stored electrical power supplied to the inverter 30 from the capacitor 40 may be determined based on a difference between the currently generated amount of generated electrical power and the required amount of electrical power. Thus, the load 60 may normally operate using the generated electrical power and the portion of the stored electrical power supplied to the inverter 30.

Next, the controller 202 may output the current operation state of the photovoltaic power generation system 1 to the display 204 in step S114. In this case, the display 204 may display the currently generated amount of generated electrical power, a real-time charge amount of the capacitor 40, the power consumption of the load 60, the current power flow state of the photovoltaic power generation system 1, and the like. The current power flow state of the photovoltaic power generation system 1 is illustrated in FIG. 3D.

When the stored electrical power does not currently exist in the capacitor 40 in step S112, the controller 202 may output the path control signal of a corresponding state to the path selector 203 and may output the driving control signal of a corresponding state to the inverter 30 in step S115.

Thus, the generated electrical power applied to the inverter 30 through the path selector 203 may be converted into the AC power and then applied to the load 60. Further, the commercial power source from the commercial power source 50 may be applied to the load 60 through the path selector 203. In this case, the commercial power source applied to the load 60 may be determined based on the difference between the currently generated amount of generated electrical power and the required amount of electrical power. Hence, the load 60 may normally operate using the generated electrical power and the commercial power source.

Next, the controller 202 may output the current operation state of the photovoltaic power generation system 1 to the display 204 in step S116. In this case, the display 204 may display the currently generated amount of generated electrical power, the power consumption of the load 60, the current power flow state of the photovoltaic power generation system 1 illustrated in FIG. 3E, and the like.

When the operation mode selected by the user is not the load driving mode in step S12, the controller 202 may control the operation of the photovoltaic power generation system 1 based on an operation illustrated in FIG. 2B.

More specifically, as shown in FIG. 2B, when the operation mode selected by the user is the power sale mode in step S21, the controller 202 may decide whether the stored electrical power exists in the capacitor 40 in step S22.

When the stored electrical power exists in the capacitor 40, the controller 202 may compare an amount of electrical power currently stored in the capacitor 40 with the required amount of electrical power in step S23.

When the currently charged amount of electrical power is equal to or more than the required amount of electrical power, the controller 202 may respectively output corresponding control signals to the path selector 203, the inverter 30, and the capacitor 40 in step S24.

Accordingly, the path selector 203 may output the applied generated electrical power to the inverter 30, and the inverter 30 may convert the input generated electrical power into AC power. The inverter 30 may then transfer the AC power to the commercial power source 50 and sell it to the commercial power source 50. The capacitor 40 may transfer the stored electrical power to the inverter 30 in response to the control signal from the controller 202. The inverter 30 may convert the stored electrical power received from the capacitor 40 into AC power and then supply the AC power to the load 60. As above, when the stored electrical power exists in the capacitor 40, the photovoltaic power generation system 1 may sell the generated electrical power generated in the photovoltaic power generator 10 to the commercial power source 50 and drive the load 60 using the power of the capacitor 40.

Next, the controller 202 may output the current operation state of the photovoltaic power generation system 1 to the display 204 in step S25. In this case, the display 204 may display the current charge amount of the capacitor 40, the power consumption of the load 60, the sale amount of electrical power, the sale price corresponding to the sale amount of electrical power, the current power flow state of the photovoltaic power generation system 1 illustrated in FIG. 3F, and the like.

When the current charge amount of the capacitor 40 is less than the required amount of electrical power in step S23, the controller 202 may decide that the load 60 cannot be normally driven using only the current charge of the capacitor 40.

Accordingly, the controller 202 may output the path control signal of a corresponding state to the path selector 203 and may output the driving control signal of a corresponding state to the inverter 30 and the capacitor 40 in step S26. Further, the controller 202 may cause the generated electrical power to be sold to the commercial power source 50 through the inverter 30 and cause the load 60 to be normally driven using the stored electrical power of the capacitor 40 through the inverter 30 and the commercial power source through the path selector 203. The amount of commercial electrical power applied to the load 60 may be determined based on the difference between the current charge amount and the required amount of electrical power.

Next, the controller 202 may output the current operation state of the photovoltaic power generation system 1 to the display 204 in step S27. The display 204 may display the currently generated amount of generated electrical power, the real-time charge amount of the capacitor 40, the power consumption of the load 60, the sale amount of electrical power, the sale price, the current power flow state of the photovoltaic power generation system 1 illustrated in FIG. 3G, and the like.

When the stored electrical power does not exist in the capacitor 40 in step S22, the controller 202 may output the path control signal of a corresponding state to the path selector 203 and may output the driving control signal of a corresponding state to the inverter 30 in step S28.

Accordingly, the path selector 203 may transfer the generated electrical power from the photovoltaic power generator 10 to the inverter 30, and the inverter 30 may convert the generated electrical power into the AC power. The inverter 30 may then supply the AC power to the commercial power source 50 and sell it to the commercial power source 50. Further, the path selector 203 may supply the commercial power source received from the commercial power source 50 to the load 60, and the load 60 may operate using the commercial power source.

Next, the controller 202 may output the current operation state of the photovoltaic power generation system 1 to the display 204 in step S29. The display 204 may display the currently generated amount of generated electrical power, the sale amount of electrical power, the sale price, the power consumption of the load 60, the current power flow state of the photovoltaic power generation system 1 illustrated in FIG. 3H, and the like.

In steps S24, S26, and 28 illustrated in FIG. 2B, when the power consumption of the load 60 is substantially zero or the load 60 is not connected to the photovoltaic power generation system 1, the controller 202 may control the operation of the path selector 203 so that the stored electrical power and/or the commercial power is blocked from being to the load 60.

When the operation mode selected by the user is not the power sale mode in step S21, the controller 202 may decide that the operation mode selected by the user is the charging mode in step S31.

Then, the controller 202 may decide whether the current state of the capacitor 40 is a power chargeable state in step S32.

When the current state of the capacitor 40 is the power chargeable state, the controller 202 may output the path control signal to the path selector 203 and supply the generated electrical power from the photovoltaic power generator 10 to the capacitor 40 in step S33. Hence, the capacitor 40 may perform the charging operation. Further, the controller 202 may supply the commercial power source from the commercial power source 50 to the load 60, so as to drive the load 60.

Next, the controller 202 may display the operations state of the photovoltaic power generation system 1 using the display 204 in step S34. Thus, the display 204 may display the currently generated amount of generated electrical power, the real-time charge amount of the capacitor 40, the charge intensity, the power consumption of the load 60, the current power flow state of the photovoltaic power generation system 1 illustrated in FIG. 3I, and the like.

Next, the controller 202 may decide whether the charging operation of the capacitor 40 is completed in step S35.

When the charging operation of the capacitor 40 is not completed, the controller 202 may return to step S11 illustrated in FIG. 2A and continuously control the charging operation of the capacitor 40.

When the charging operation of the capacitor 40 is completed and the capacitor 40 reaches a maximum charge state, the controller 202 may control the driving of the load 60 using the generated electrical power.

Thus, the controller 202 may compare the currently generated amount of generated electrical power of the photovoltaic power generator 10 with the amount of electrical power required to drive the load 60 in step S36.

When the currently generated amount of generated electrical power is more than the required amount of electrical power, the controller 202 may output the path control signal and the driving control signal to the path selector 203 and the inverter 30, respectively.

Hence, the path selector 203 may supply the total generated electrical power to the inverter 30, and the inverter 30 may convert the total generated electrical power into the AC power. The inverter 30 may then supply the generated electrical power corresponding to a power amount required to drive the load 60 to the load 60 in response to the driving control signal, output the remaining generated electrical power to the commercial power source 50, and sell the remaining generated electrical power to the commercial power source 50. However, when the power consumption is not generated in the load 60, the total generated electrical power may be output to the commercial power source 50 and may be sold to the commercial power source 50.

Next, the controller 202 may output the display control signal to the display 204 in step S38. Thus, the display 204 may display the currently generated amount of generated electrical power, the power consumption of the load 60, the sale amount of electrical power, the sale price, the current power flow state of the photovoltaic power generation system 1 illustrated in FIG. 3B, and the like. When the power consumption is not generated in the load 60, the total generated electrical power through the inverter 30 may flow in the commercial power source 50 unlike the current power flow state illustrated in FIG. 3B.

When the currently generated amount of generated electrical power of the photovoltaic power generator 10 is equal to or less than the required amount of electrical power in step S36, the controller 202 may respectively output the control signals of a corresponding state to the path selector 203 and the inverter 30 so as to control the driving of the load 60 using the generated electrical power and/or the commercial power source in step S39.

Thus, the path selector 203 may output the generated electrical power from the photovoltaic power generator 10 to the inverter 30, and the inverter 30 may supply the AC generated electrical power to the load 60. When the amount of the generated electrical power is insufficient to drive the load 60, the path selector 203 additionally may supply the commercial power source from the commercial power source 50 to the load 60 under the control of the controller 202, thereby causing the load 60 to normally operate.

Next, the controller 202 may cause the current operation state of the photovoltaic power generation system 1 to be displayed on the display 204 in step S310. Thus, the display 204 may display the currently generated amount of generated electrical power, the real-time charge amount of the capacitor 40, the power consumption of the load 60, the current power flow state of the photovoltaic power generation system 1 illustrated in FIG. 3C or 3E, and the like.

When the current state of the capacitor 40 is not in the power chargeable state in step S32, the controller 202 may proceed to the step S36 described above and control the operation of the photovoltaic power generation system 1.

In steps S37 and S39 illustrated in FIG. 2C, when the power consumption of the load 60 is substantially zero or the load 60 is not connected to the photovoltaic power generation system 1, the controller 202 may control the operation of the path selector 203 so that the generated electrical power and/or the commercial power may be blocked from being supplied to the load 60 and the generated electrical power may be applied the capacitor 40 or the commercial power source 50.

In the current power flow state illustrated in FIGS. 3A to 3I, when the generated electrical power is not generated in the photovoltaic power generator 10, for example, in a rainy day or at night, the arrow moving from the content 101 of the photovoltaic power generator 10 to the content 102 of the inverter 30 or the content 103 of the capacitor 40 may not be illustrated. Further, the form or color of the contents indicating a flow direction of the power may variously vary.

As described above, when the power consumption of the load 60 is not generated because the load 60 is not connected to the photovoltaic power generation system 1 or the load 60 connected to the photovoltaic power generation system 1 does not operate, the controller 202 may control the operation of the path selector 203 so that the generated electrical power and/or the commercial power is blocked from being supplied to the load 60. Instead, the generated electrical power may be stored in the capacitor 40 or may be sold to the commercial power source 50.

Because the user may use the generated electrical power generated in the photovoltaic power generator 10 in the driving of the load 60 and also may sell the generated electrical power using the photovoltaic power generation system 1, the photovoltaic power generation system 1 may provide economic benefits to the user. Further, because a loss of the generated electrical power generated in real-time decreases, the use efficiency of the generated electrical power may be greatly improved.

Furthermore, because the user may drive the photovoltaic power generation system 1 in the user's desired operation mode using the operation mode selection receiver 201, the generated electrical power may be used to meet the user's requirement. Thus, the user satisfaction may be improved.

In addition, because the user may know the sale price and the sale amount of the generated electrical power sold to the commercial power source 50, the charge intensity of the capacitor 40, and the current charge amount of the capacitor 40, the user satisfaction may be further improved.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A photovoltaic power generation system, comprising:
a photovoltaic power generator configured to output an electrical power generated using light;
an inverter configured to convert the generated electrical power into an alternating current (AC) power and supply the AC power to a commercial power source or to a load;
a capacitor configured to store the generated electrical power; and
a monitor configured to direct the generated electrical power to the inverter or the capacitor based on an operation mode selected by a user.

2. The photovoltaic power generation system of claim 1, wherein the monitor includes:
an operation mode selection receiver configured to receive an operation mode selection from the user and output an operation mode signal;
a controller configured to receive the operation mode signal and output a control signal based on the operation mode signal; and
a path selector configured to receive the control signal and select a path that directs the generated electrical power to the inverter or the capacitor based on the control signal.

3. The photovoltaic power generation system of claim 2, wherein the operation mode is selected from at least one of:
a load driving mode for driving the load using the generated electrical power;
a power sale mode for selling the generated electrical power to the commercial power source; and
a charging mode for storing the generated electrical power in the capacitor.

4. The photovoltaic power generation system of claim 3, wherein in the load driving mode, the controller compares an amount of generated electrical power with an amount of electrical power required to drive the load, and
wherein when the amount of generated electrical power is equal to or more than the required amount of electrical power, the controller outputs a control signal for selecting a path that directs the generated electrical power to the load.

5. The photovoltaic power generation system of claim 4, wherein the controller decides whether an excess generated electrical power exists, and
wherein when the excess generated electrical power exists, the controller outputs a control signal for storing the excess generated electrical power in the capacitor or for selling the excess generated electrical power to the commercial power source.

6. The photovoltaic power generation system of claim 5, wherein the controller decides whether the capacitor is in a chargeable state,
wherein when the capacitor is in the chargeable state, the controller outputs a control signal for storing the excess generated electrical power in the capacitor, and
wherein when the capacitor is not in the chargeable state, the controller outputs a control signal for selling the excess generated electrical power to the commercial power source.

7. The photovoltaic power generation system of claim 4, wherein when the amount of generated electrical power is less than the required amount of electrical power, the controller outputs a control signal for supplying a commercial electrical power provided by the commercial power source or for supplying a stored electrical power of the capacitor to the load.

8. The photovoltaic power generation system of claim 7, wherein the controller decides whether the stored electrical power exists in the capacitor,
wherein when the stored electrical power exists in the capacitor, the controller outputs a control signal for supplying the stored electrical power to the load,
wherein when the stored electrical power does not exist in the capacitor, the controller outputs a control signal for supplying the commercial electrical power to the load.

9. The photovoltaic power generation system of claim 3, wherein in the power sale mode, the controller outputs a control signal for selecting a path that directs the generated electrical power to the commercial power source.

10. The photovoltaic power generation system of claim 9, wherein the controller decides whether a stored electrical power exists in the capacitor,
wherein when the stored electrical power exists in the capacitor, the controller compares an amount of stored electrical power with an amount of electrical power required to drive the load,
wherein when the amount of stored electrical power is equal to or more than the required amount of electrical power, the controller outputs a control signal for selling the generated electrical power to the commercial power source and for supplying the stored electrical power to the load, and
wherein when the amount of stored electrical power is less than the required amount of electrical power, the controller outputs a control signal for selling the generated electrical power to the commercial power source and for supplying the stored electrical power and a commercial electrical power provided by the commercial power source to the load.

11. The photovoltaic power generation system of claim 10, wherein when the stored electrical power does not exist in the capacitor, the controller outputs a control signal for selling the generated electrical power to the commercial power source and supplying the commercial electrical power to the load.

12. The photovoltaic power generation system of claim 3, wherein in the charging mode, the controller decides whether the capacitor is in a chargeable state,
wherein when the capacitor is in the chargeable state, the controller outputs a control signal for selecting a path directing the generated electrical power to the capacitor.

13. The photovoltaic power generation system of claim 12, wherein the controller outputs a control signal for supplying a commercial electrical power provided by the commercial power source to the load.

14. The photovoltaic power generation system of claim 12, wherein when the capacitor is not in the chargeable state, the controller compares an amount of generated electrical power with an amount of electrical power required to drive the load,
wherein when the amount of generated electrical power is more than the required amount of electrical power, the controller outputs a control signal for supplying a portion of the generated electrical power to the load and for supplying an excess generated electrical power to the commercial power source,
wherein when the amount of generated electrical power is less than the required amount of electrical power, the controller outputs a control signal for supplying the generated electrical power and a commercial electrical power provided by the commercial power source to the load,
wherein when the amount of generated electrical power is substantially equal to the required amount of electrical power, the controller outputs a control signal for supplying the generated electrical power to the load.

15. The photovoltaic power generation system of claim 2, further comprising a display configured to display an operation state of the photovoltaic power generation system in response to a control signal from the controller.

16. The photovoltaic power generation system of claim 15, wherein the display displays at least one of an amount of generated electrical power, an amount of stored electrical power, an amount of sold electrical power, a sale price of electrical power, and a power intensity, in response to the control signal from the controller.

17. The photovoltaic power generation system of claim 15, wherein the display displays a power flow state of the photovoltaic power generation system in response to the control signal from the controller.

18. A method for controlling a photovoltaic power generation system, comprising:
receiving an operation mode selection from a user;
when the operation mode is a load driving mode, selecting a path of a generated electrical power from a photovoltaic power generator to a load;
when the operation mode is a power sale mode, selecting a path of the generated electrical power from the photovoltaic power generator to a commercial power source; and
when the operation mode is a charging mode, selecting a path of the generated electrical power from the photovoltaic power generator to a capacitor.

19. The method of claim 18, wherein when the operation mode is a load driving mode, comparing an amount of generated electrical power with an amount of electrical power required to drive the load,
when the amount of generated electrical power is equal to or more than the required amount of electrical power, deciding whether an excess generated electrical power exists, and
when the excess generated electrical power exists, outputting a control signal for storing the excess generated electrical power in the capacitor or for selling the excess generated electrical power to the commercial power source.

20. The method of claim 19, wherein when the excess generated electrical power exists, deciding whether the capacitor is in a chargeable state,
when the capacitor is in the chargeable state, outputting a control signal for supplying the generated electrical power to the load and storing the excess generated electrical power in the capacitor, and
when the capacitor is not in the chargeable state, outputting a control signal for supplying the generated electrical power to the load and selling the excess generated electrical power to the commercial power source.

21. The method of claim 19, wherein when the amount of generated electrical power is less than the required amount of electrical power, outputting a control signal for supplying a commercial electrical power provided by the commercial power supply or a stored electrical power of the capacitor to the load.

22. The method of claim 21, wherein when the amount of generated electrical power is less than the required amount of electrical power, deciding whether the stored electrical power exists in the capacitor;
when the stored electrical power exists in the capacitor, outputting a control signal for supplying the generated electrical power and the stored electrical power to the load; and
when the stored electrical power does not exist in the capacitor, outputting a control signal for supplying the generated electrical power and the commercial electrical power to the load.

23. The method of claim 18, wherein when the operation mode is a power sale mode,
deciding whether a stored electrical power exists in the capacitor,
when the stored electrical power exists in the capacitor, comparing an amount of stored electrical power with an amount of electrical power required to drive the load,
when the amount of stored electrical power is equal to or more than the required amount of electrical power, outputting a control signal for supplying the generated electrical power to the commercial power source and for supplying the stored electrical power to the load; and
when the amount of stored electrical power is less than the required amount of electrical power, outputting a control signal for selling the generated electrical power to the commercial power source and for supplying the stored electrical power and a commercial electrical power provided by the commercial power source to the load.

24. The method of claim 23, wherein when the stored electrical power does not exist in the capacitor, outputting a control signal for selling the generated electrical power to the commercial power source and for supplying the commercial electrical power to the load.

25. The method of claim 18, wherein when the operation mode is a charging mode, deciding whether the capacitor is in a chargeable state; and
when the capacitor is in the chargeable state, outputting a control signal for supplying the generated electrical power to the capacitor.

26. The method of claim 25, wherein when the capacitor is in the chargeable state, outputting a control signal for supplying a commercial electrical power provided by the commercial power source to the load.

27. The method of claim 25, wherein when the capacitor is not in the chargeable state, comparing an amount of generated electrical power with an amount of electrical power required to drive the load;
when the amount of generated electrical power is more than the required amount of electrical power, outputting a control signal for supplying a portion of the generated electrical power to the load and for supplying an excess generated electrical power to the commercial power source;
when the amount of generated electrical power is less than the required amount of electrical power, outputting a control signal for supplying the generated electrical power and a commercial electrical power provided by the commercial power source to the load; and
when the amount of generated electrical power is substantially equal to the required amount of electrical power, outputting a control signal for supplying the generated electrical power to the load.

28. The method of claim 18, further comprising displaying an operation state of the photovoltaic power generation system on a display.

29. The method of claim 28, wherein the display displays a current power flow state of the photovoltaic power generation system.

30. The method of claim 28, wherein the display displays at least one of an amount of generated electrical power, an amount of stored electrical power, an amount of sold power, a sale price of the electrical power, and a power intensity.

31. A system for controlling a photovoltaic power generation system, comprising:
operation mode selection receiver configured to receive an operation mode selection from an user and to output an operation mode signal;
a controller configured to receive the operation mode signal and output a control signal based on the operation mode signal; and
a path selector configured to received the control signal and select a path that directs an electrical power generated by a photovoltaic generator to an inverter or a capacitor based on the control signal.
